(19) United States
(12) Patent Application Publication
(10) Pub. No.: US 2019/0193580 A1
(43) Pub. Date: Jun. 27, 2019

(54) ELECTRIC VEHICLE

(71) Applicant: TOYOTA JIDOSHA KABUSHIKI KAISHA, Toyota-shi (JP)

(72) Inventor: Tsutomu SHIRAKAWA, Toyota-shi (JP)

(21) Appl. No.: 16/213,343

(22) Filed: Dec. 7, 2018

(30) Foreign Application Priority Data
Dec. 21, 2017 (JP) 2017-244593

(51) Int. Cl. B60L 50/70; H01M 8/04082; H01M 8/02; H01M 8/04858

(52) U.S. Cl. CPC B60L 50/70; H01M 8/04201; H01M 8/02; B60Y 2200/91; H01M 2250/20; B60Y 2400/202; H01M 8/04932

(57) ABSTRACT

Provided is an electric vehicle in which impacts on a high-voltage connector from at least one of a dashboard or a cowl member can be suppressed. The electric vehicle includes a case disposed ahead of the dashboard and the cowl member of the vehicle, the case being adapted to house a high-voltage component, a high-voltage connector disposed on the upper face of the case and connected to the high-voltage component; and an auxiliary unit disposed on the upper face of the case. The auxiliary unit is disposed closer to the dashboard than is the high-voltage connector, and is formed of a material with higher rigidity than those of the dashboard and the cowl member.

### CROSS REFERENCE TO RELATED APPLICATIONS

The present application claims priority from Japanese patent application JP 2017-244593 filed on Dec. 21, 2017, the content of which is hereby incorporated by reference into this application.

### BACKGROUND

### Technical Field

The present disclosure relates to an electric vehicle.

### Background Art

As an electric vehicle, a fuel cell vehicle described in JP 2017-74819A is known, for example. In the electric vehicle described in JP 2017-74819A, a case housing a high-voltage component connected to fuel cells is disposed ahead of a dashboard and a cowl member.

In such an electric vehicle, it is supposed that a high-voltage connector that is connected to the high-voltage component is disposed on the upper face of the case housing the high-voltage component. In that case, there is a possibility that the high-voltage connector may receive impacts from the dashboard, the cowl member, or both the dashboard and the cowl member due to collision or the like. In order to protect the high-voltage connector, it would be necessary to suppress impacts on the high-voltage connector from at least one of the dashboard or the cowl member.

### SUMMARY

The present disclosure has been made in view of the foregoing. Exemplary embodiments relate to providing an electric vehicle in which impacts on a high-voltage connector from at least one of a dashboard or a cowl member can be suppressed.

An electric vehicle in accordance with the present disclosure includes a case disposed ahead of a dashboard and a cowl member of the vehicle, the case being adapted to house a high-voltage component; a high-voltage connector disposed on the upper face of the case and connected to the high-voltage component; and an auxiliary unit disposed on the upper face of the case, in which the auxiliary unit is disposed closer to the dashboard than is the high-voltage connector, and has higher rigidity than those of the dashboard and the cowl member.

In the electric vehicle in accordance with the present disclosure, since the auxiliary unit is disposed closer to the dashboard than is the high-voltage connector, and has higher rigidity than those of the dashboard and the cowl member, even when the case collides with at least one of the dashboard or the cowl member, impacts from at least one of the dashboard or the cowl member can be received by the auxiliary unit. Therefore, impacts on the high-voltage connector from at least one of the dashboard or the cowl member can be suppressed, and thus, the high-voltage connector can be protected. Further, if the auxiliary unit is also used as a member for protecting the high-voltage connector, the need for adding a new component can be eliminated. Thus, an increase in the weight and cost associated with the addition of a new component can be suppressed.

In some embodiments, the electric vehicle in accordance with the present disclosure may further include an electric wire connected to the high-voltage connector, and the electric wire may be wired along the width direction of the vehicle or toward the front side of the vehicle. Accordingly, impacts on the electric wire from at least one of the dashboard or the cowl member can be reduced as long as the electric wire connected to the high-voltage connector is wired in a direction away from the dashboard and the cowl member.

In some embodiments, the electric vehicle in accordance with the present disclosure may further include a fuel cell, and the auxiliary unit may be a hydrogen supply unit adapted to supply hydrogen gas to the fuel cell. Accordingly, impacts on the high-voltage connector from at least one of the dashboard or the cowl member can be suppressed by using the hydrogen supply unit with high rigidity, and thus, the high-voltage connector can be protected more reliably.

According to the present disclosure, impacts on the high-voltage connector from at least one of the dashboard or the cowl member can be suppressed.

### BRIEF DESCRIPTION OF THE DRAWINGS

FIG. 1 is a schematic plan view illustrating the configuration of an electric vehicle in accordance with the first embodiment;

FIG. 2 is a schematic side view illustrating the configuration of the electric vehicle in accordance with the first embodiment;

FIG. 3 is a schematic plan view illustrating the configuration of an electric vehicle in accordance with the second embodiment;

FIG. 4 is a schematic plan view illustrating the configuration of an electric vehicle in accordance with the third embodiment; and

FIG. 5 is a schematic plan view illustrating the configuration of an electric vehicle in accordance with the fourth embodiment.

### DETAILED DESCRIPTION

Hereinafter, an embodiment of an electric vehicle in accordance with the present disclosure will be described with reference to the drawings. In each drawing, the arrows FR, RH, and UP indicate the front side, right side, and upper side of the vehicle, respectively.

### First Embodiment

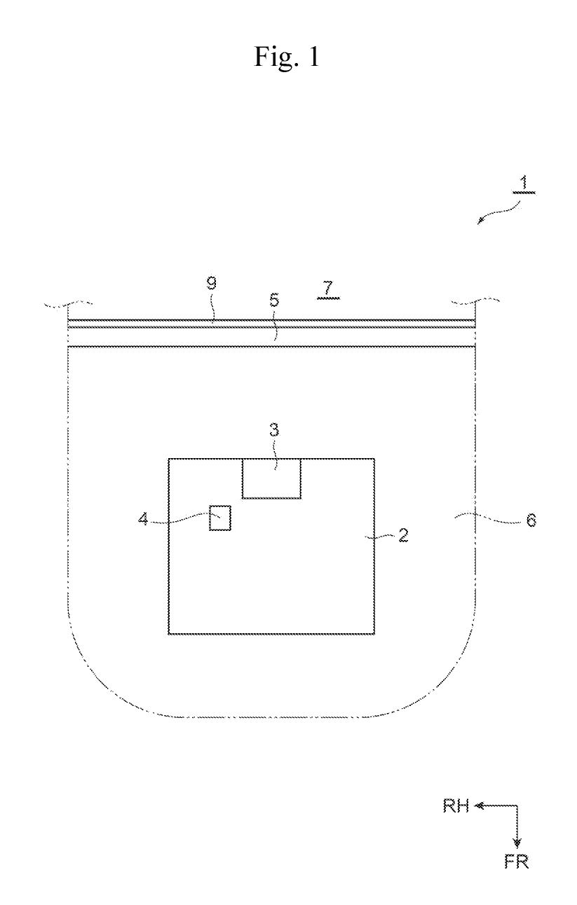

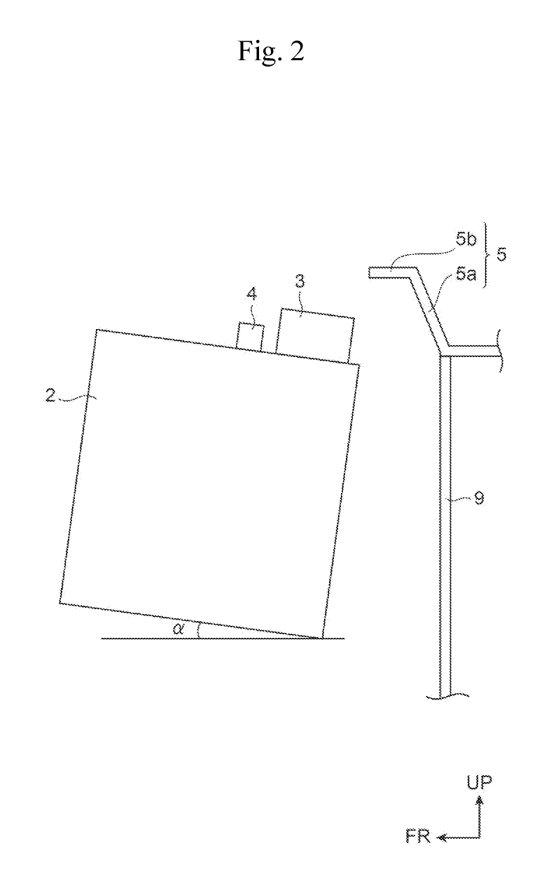

FIG. 1 is a schematic plan view illustrating the configuration of an electric vehicle in accordance with the first embodiment, and FIG. 2 is a schematic side view illustrating the configuration of the electric vehicle in accordance with the first embodiment. An electric vehicle 1 of this embodiment is, for example, a fuel cell vehicle with fuel cells, for example, and mainly includes a dashboard 9 that separates a front compartment 6 from a vehicle cabin 7, a case 2 that is mounted in substantially the center of the front compartment 6 and houses a high-voltage component, and an auxiliary unit 3 that is disposed on the upper face of the case 2.

The dashboard 9 is formed of a metallic material or a fiber-reinforced resin material, and extends along the width direction of the vehicle (also referred to as a “right-left direction” of the vehicle). A cowl member 5 extending along the width direction of the vehicle is disposed above the dashboard 9. The cowl member 5 includes a cowl panel 5a that has a substantial L-shaped cross-section and is joined to the upper end of the dashboard 9 through welding or the like, and a cowl louver 5b coupled to the upper end of the cowl panel 5a (see FIG. 2). The case 2 is a housing with a substantially rectangular parallelepiped shape and formed of a metallic material, for example, and is disposed ahead of the dashboard 9 and the cowl member 5. The case 2 houses a fuel cell power control unit (that is, an FCPC), for example.

As illustrated in FIG. 2, the case 2 is disposed in the front compartment 6 in a state in which the bottom face of the case 2 is inclined at a predetermined angle α with respect to the horizontal direction. Specifically, the case 2 is inclined such that it becomes lower toward the rear side of the vehicle, that is, inclined downward toward the rear side. Such a structure is obtained through the exercise of ingenuity to efficiently discharge water generated during the power generation of the fuel cells to the outside. It should be noted that the case 2 need not necessarily be inclined downward toward the rear side, and may be disposed along the horizontal direction or disposed such that it is inclined downward toward the front side.

A high-voltage connector 4, which is connected to the high-voltage component (herein, an FCPC) housed in the case 2, is disposed on the upper face of the case 2. The high-voltage connector 4 is electrically connected to the high-voltage component via soldering or bolt fastening, for example, and is also fixed on the upper face of the case 2. As illustrated in FIG. 1, the high-voltage connector 4 is disposed on the right side with respect to the central axis of the vehicle.

The auxiliary unit 3 is a hydrogen supply unit that supplies hydrogen gas to the fuel cells, for example, and is fixed on the upper face of the case 2 through welding, bolt fastening, or the like. The hydrogen supply unit is configured to include a buffer tank for temporarily storing hydrogen gas, and an injector for adjusting the pressure and flow rate of the hydrogen gas, for example.

The auxiliary unit 3 is formed of a material with higher rigidity than those of the dashboard 9 and the cowl member 5, and is positioned closer to the dashboard 9 than is the high-voltage connector 4. As illustrated in FIG. 1, when seen from the front-rear direction of the vehicle, the high-voltage connector 4 is not disposed right in front of the auxiliary unit 3, but is disposed at a position displaced from the auxiliary unit 3 to the right side in the vehicle and a position ahead of the auxiliary unit 3.

In addition, as illustrated in FIG. 2, the auxiliary unit 3 is disposed at a position lower than the cowl member 5 in the height direction of the vehicle (also referred to as a “vertical direction” of the vehicle). In addition, the high-voltage connector 4 is disposed at a position lower than the auxiliary unit 3.

In the electric vehicle 1 configured as above, the auxiliary unit 3 is disposed closer to the dashboard 9 than is the high-voltage connector 4, and has higher rigidity than those of the dashboard 9 and the cowl member 5. Therefore, even when the case 2 collides with the dashboard 9, impacts from the dashboard 9 are received by the auxiliary unit 3, so that impacts on the high-voltage connector 4 from the dashboard 9 can be suppressed, and thus, the high-voltage connector 4 can be protected. Further, even when the case 2 collides with the cowl member 5, impacts from the cowl member 5 are received by the auxiliary unit 3, so that impacts on the high-voltage connector 4 from the cowl member 5 can be suppressed, and thus, the high-voltage connector 4 can be protected. Further, even when the case 2 collides with the dashboard 9 and the cowl member 5, impacts from the dashboard 9 and the cowl member 5 are received by the auxiliary unit 3, so that impacts on the high-voltage connector 4 from the dashboard 9 and the cowl member 5 can be suppressed, and thus, the high-voltage connector 4 can be protected. Further, if the auxiliary unit 3 is used as a member for protecting the high-voltage connector 4, the need for adding a new component can be eliminated. Thus, an increase in the weight and cost associated with the addition of a new component can be suppressed.

In addition, as described above, since the case 2 is inclined downward toward the rear side with respect to the horizontal direction, the distance from the high-voltage connector 4 disposed on the upper face of the case 2 to the dashboard 9 and the distance from the high-voltage connector 4 to the cowl member 5 become shorter as compared to when the case 2 is disposed along the horizontal direction. Consequently, the high-voltage connector 4 becomes more likely to receive impacts from at least one of the dashboard 9 or the cowl member 5. In addition, when the auxiliary unit 3 is disposed closer to the dashboard 9 than is the high-voltage connector 4, if the case 2 bumps against at least one of the dashboard 9 or the cowl member 5 due to collision or the like, impacts from at least one of the dashboard 9 or the cowl member 5 are received by the auxiliary unit 3 with higher rigidity than those of the dashboard 9 and the cowl member 5, so that impacts on the high-voltage connector 4 from at least one of the dashboard 9 or the cowl member 5 can be reduced, and thus, the high-voltage connector 4 can be protected.

Further, as described above, since the high-voltage connector 4 is protected against impacts from at least one of the dashboard 9 or the cowl member 5 by the auxiliary unit 3, the high-voltage connector 4 can be disposed at a position close to the dashboard 9, a position close to the cowl member 5, or a position close to both the dashboard 9 and the cowl member 5. Consequently, flexibility in disposing the high-voltage connector 4 can be improved, enabling the high-voltage connector 4 to be disposed in a limited space.

### Second Embodiment

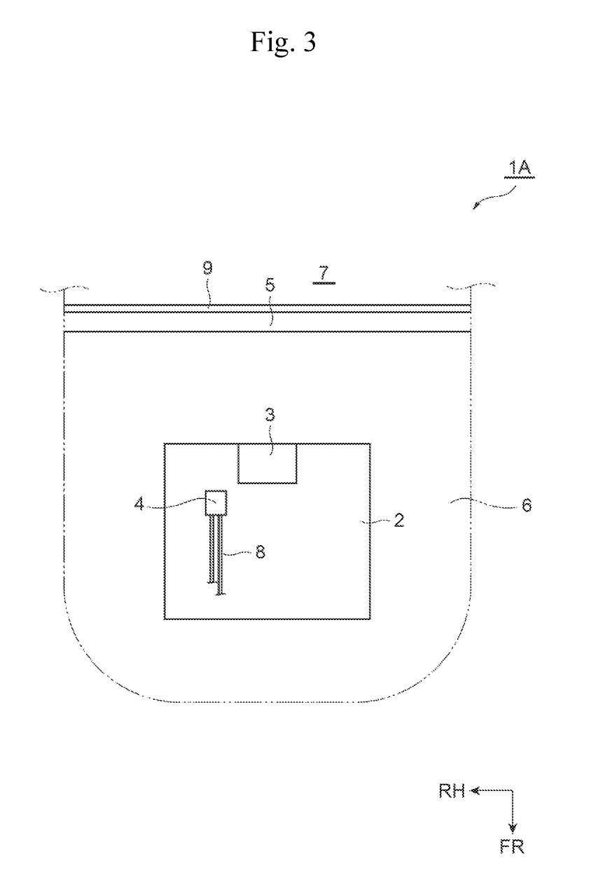

FIG. 3 is a schematic plan view illustrating the configuration of an electric vehicle in accordance with the second embodiment. An electric vehicle 1A of this embodiment differs from that of the aforementioned first embodiment in further including electric wires 8 that are connected to the high-voltage connector 4. However, the other configurations are the same as those of the first embodiment, and thus, a repeated description thereof will be omitted.

As illustrated in FIG. 3, a plurality of electric wires 8 that are electrically connected to the high-voltage connector 4 are disposed on the upper face of the case 2. Such electric wires 8 are wired toward the front side of the vehicle. Since the electric vehicle 1A configured in such a manner can obtain similar operational effects to those of the aforementioned first embodiment, and the electric wires 8 connected to the high-voltage connector 4 are wired toward the front side of the vehicle, impacts on the electric wires 8 from at least one of the dashboard 9 or the cowl member 5 can be reduced as long as the electric wires 8 are wired in a direction away from the dashboard 9 and the cowl member 5.

It should be noted that the electric wires 8 need not necessarily be wired toward the front side of the vehicle, and may be wired toward a lateral side of the vehicle along the width direction, for example.

### Third Embodiment

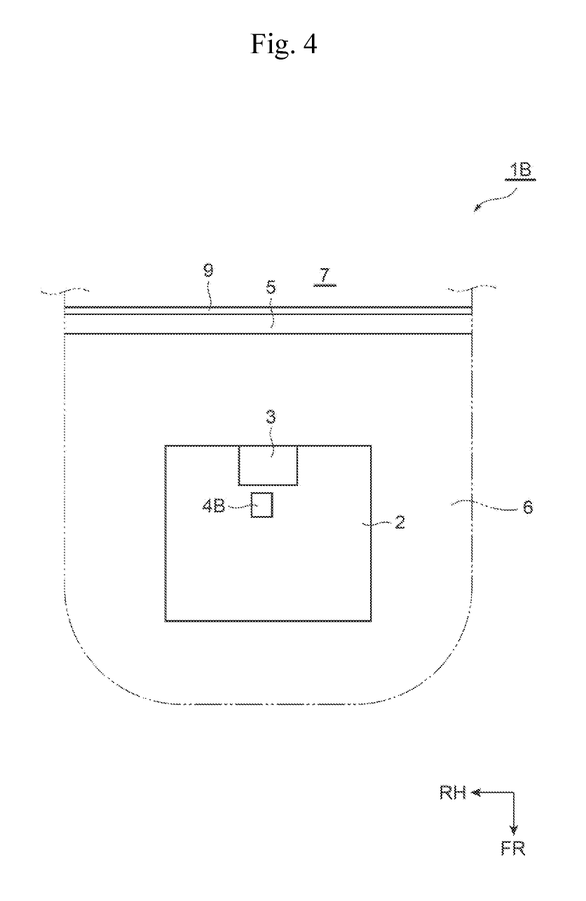

FIG. 4 is a schematic plan view illustrating the configuration of an electric vehicle in accordance with the third embodiment. An electric vehicle 1B of this embodiment differs from that of the aforementioned first embodiment in the position of the high-voltage connector 4. However, the other configurations are the same as those of the first embodiment, and thus, a repeated description thereof will be omitted.

As illustrated in FIG. 4, when seen from the front-rear direction of the vehicle, a high-voltage connector 4B is disposed right in front of the auxiliary unit 3 so as to face the auxiliary unit 3. Since the electric vehicle 1B configured in such a manner can obtain similar operational effects to those of the aforementioned first embodiment, and the high-voltage connector 4B is disposed right in front of the auxiliary unit 3, the effect of suppressing impacts on the high-voltage connector 4B from at least one of the dashboard 9 or the cowl member 5 can be further enhanced as long as the auxiliary unit 3 is disposed between the high-voltage connector 4B and the dashboard 9.

It should be noted that the high-voltage connector need not necessarily be disposed right in front of the auxiliary unit 3, and may be disposed at a position closer to the auxiliary unit 3 than to the right-side end in the width direction of the vehicle.

### Fourth Embodiment

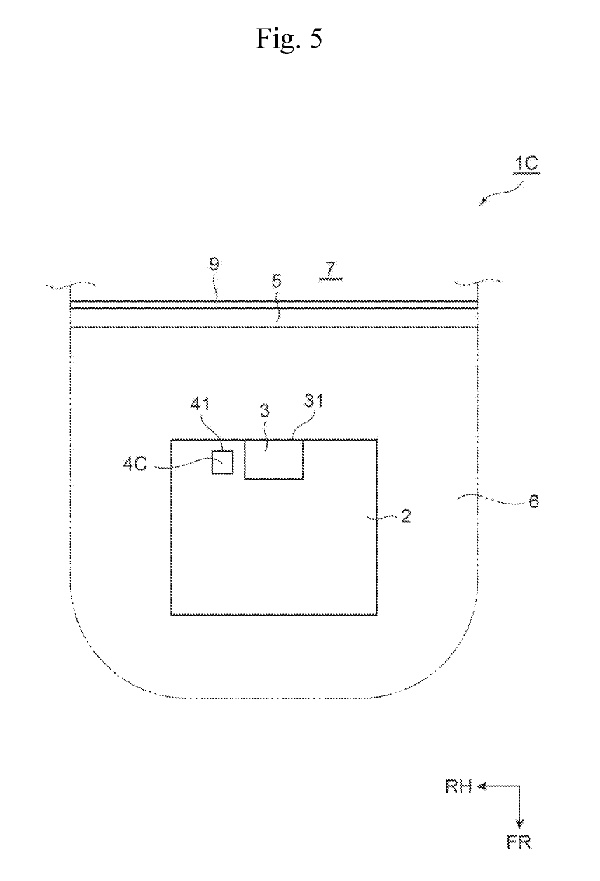

FIG. 5 is a schematic plan view illustrating the configuration of an electric vehicle in accordance with the fourth embodiment. An electric vehicle 1C of this embodiment differs from that of the aforementioned first embodiment in that a high-voltage connector 4C is not disposed in front of the auxiliary unit 3. However, the other configurations are the same as those of the first embodiment, and thus, a repeated description thereof will be omitted.

As illustrated in FIG. 5, the auxiliary unit 3 is disposed closer to the dashboard 9 than is the high-voltage connector 4C, and the high-voltage connector 4C is disposed on the right side of and just beside the auxiliary unit 3. In addition, an end face 31 facing the dashboard 9 of the auxiliary unit 3 is disposed closer to the dashboard 9 than is an end face 41 facing the dashboard 9 of the high-voltage connector 4C. The electric vehicle 1C configured in such a manner can obtain similar operational effects to those of the aforementioned first embodiment.

Although the embodiments of the present disclosure have been described in detail above, the present disclosure is not limited thereto, and a variety of design changes are possible within the spirit and scope of the present disclosure recited in the appended claims. For example, although a hydrogen supply unit is described as an example of the auxiliary unit 3 in the aforementioned embodiments, a water heater, an air compressor that takes in oxidation gas from the atmosphere, a hydrogen circulating pump, or the like can also be used as the auxiliary unit 3 in addition to the hydrogen supply unit. In any of such cases, similar operation effects to those of the aforementioned embodiments can be obtained.

### DESCRIPTION OF SYMBOLS

1, 1A, 1B, 1C Electric vehicle
2 Case
3 Auxiliary unit
4, 4B, 4C High-voltage connector
5 Cowl member
6 Front compartment
7 Vehicle cabin
8 Electric wire
9 Dashboard

What is claimed is:

1. An electric vehicle, comprising:
a case disposed ahead of a dashboard and a cowl member of the vehicle, the case being adapted to house a high-voltage component;
a high-voltage connector disposed on an upper face of the case and connected to the high-voltage component; and
an auxiliary unit disposed on the upper face of the case,
wherein:
the auxiliary unit is disposed closer to the dashboard than is the high-voltage connector, and has higher rigidity than those of the dashboard and the cowl member.

2. The electric vehicle according to claim 1, further comprising an electric wire connected to the high-voltage connector,
wherein:
the electric wire is wired along a width direction of the vehicle or toward a front side of the vehicle.

3. The electric vehicle according to claim 1, further comprising a fuel cell,
wherein:
the auxiliary unit is a hydrogen supply unit adapted to supply hydrogen gas to the fuel cell.
